(19) United States
(12) Patent Application Publication
(10) Pub. No.: US 2022/0143986 A1
(43) Pub. Date: May 12, 2022

(54) PRINT BAR SPACING CALIBRATIONS

(71) Applicant: Hewlett-Packard Development Company, L.P., Spring, TX (US)

(72) Inventor: Hsue-Yang LIU, Vancouver, WA (US)

(73) Assignee: Hewlett-Packard Development Company, L.P., Spring, TX (US)

(21) Appl. No.: 17/296,079

(22) PCT Filed: Jul. 25, 2019
(86) PCT No.: PCT/US2019/043358

§ 371 Date: May 21, 2021

(51) Int. Cl. B41J 2/21

(52) U.S. Cl. CPC B41J 2/2132

(57) ABSTRACT

In one example, a printing device can include a print zone that includes a print head and a print media area, wherein the print zone includes a paper to print head spacing (PPS) that corresponds to a distance between the print head and the print media area, and a computing device that includes instructions to determine a first print quality of an image on a print medium utilizing a first PPS value, and alter the first PPS value to a second PPS value based on the first print quality.

### BACKGROUND

Printing systems, such as scanning printers, page wide printers, copiers, etc., may generate text or images on to print media (e.g., paper, plastic, etc.). Printing systems can utilize a print substance that can be deposited on to the print media to generate the text or images on the print media, Printing systems can utilize a print bar with a plurality of dies that can include a corresponding plurality of orifices to deposit a print substance on to the print media.

### BRIEF DESCRIPTION OF THE DRAWINGS

FIG. 1 is an example system for print bar spacing calibrations consistent with the present disclosure.

FIG. 2 is an example system for print bar spacing calibrations consistent with the present disclosure.

FIG. 3 is an example memory resource for print bar spacing calibrations consistent with the present disclosure.

FIG. 4 is an example graphical representation for print bar spacing calibrations consistent with the present disclosure.

### DETAILED DESCRIPTION

In some examples, a printing device can be utilized to generate an image on a print medium by depositing a print substance on to the print medium. For example, the printing device can include a page wide printing device, a scanning printing device, and/or a 3D printing device. As used herein, a print substance can include a substance that is capable of generating an image on a print medium. For example, the print substance can include, but is not limited to, a fluid such as ink, a solid powder mixture such as toner, a three-dimensional (3D) print substance such as a polymer powder, among other substances that can be utilized to generate images. As used herein, a print medium can be a substrate that can receive the print substance to generate a permanent or semi-permanent image. For example, a print medium can include, but is not limited to, paper, polymer, adhesive paper, metal, among other medias that can receive the print substance.

In some examples, a printing device can include a print bar or print head that includes a plurality of print dies or a plurality of orifices to deposit a print substance. As used herein, a print bar can include a mechanism that can deposit a print substance at particular locations on the print medium to generate the image to be printed on the print medium. As used herein, a print head can include a mechanism that is capable of depositing a print substance on to a print medium. In some examples, the print bar and print head can be used interchangeably to describe a mechanism that can deposit a print substance on to a print medium. In some examples, the print bar can include a plurality of print dies that each include orifices to deposit the print substance on to the print medium. In some examples, the plurality of print dies can be spaced along the print bar such that the plurality of print dies are capable of depositing the print substance across the entire surface of the print medium. In some examples, the print bar can be moved from a first side to a second side of the print medium to deposit the print substance on to the print medium. In some examples, the printing device can utilize bidirectional printing such that the print bar can deposit the print substance moving from the first side to the second side of the print medium and also deposit the print substance moving from the second side to the first side of the print medium. In other examples, the print medium can be moved from a first side of the print bar to a second side of the print bar in a similar way such that the print bar can deposit the print substance when the print medium is positioned in a particular location below the print bar.

In some examples, the print bar and/or plurality of print dies can be positioned at a particular distance from the print medium during operations (e.g., when the print bar and/or plurality of print dies are depositing print substance, etc.). In some examples, this distance can be considered a paper to print bar spacing (PPS) and can have an effect on the print quality of images generated on the print medium. In some examples, the printing device can include a PPS value that can be a manufacturer PPS value (e.g., PPS value utilized by the manufacturer, etc.) that the printing device is manufactured with by the manufacturer. In some examples, the manufacturer setting of the PPS value can be considered a nominal PPS value.

The present disclosure relates to print bar spacing calibrations, In some examples, an image can be generated by a printing device on to a print medium. In some examples, the image can be a test image that can be generated by utilizing a plurality of different PPS values to compare a print quality of the image utilizing a plurality of different PPS values. In some examples, the comparison can be utilized to determine a particular PPS value with a relatively higher print quality compared to other PPS values that were part of the image. In some examples, the PPS value of the printing device can be altered based on the comparison of the print quality for the plurality of different PPS values. In this way, the devices and systems described herein can be utilized to increase a print quality generated by a printing device by altering the PPS value of the printing device based on the print quality generated by a plurality of different PPS values.

The figures herein follow a numbering convention in which the first digit corresponds to the drawing figure number and the remaining digits identify an element or component in the drawing. Elements shown in the various figures herein may be capable of being added, exchanged, and/or eliminated so as to provide a number of additional examples of the present disclosure. In addition, the proportion and the relative scale of the elements provided in the figures are intended to illustrate the examples of the present disclosure and should not be taken in a limiting sense.

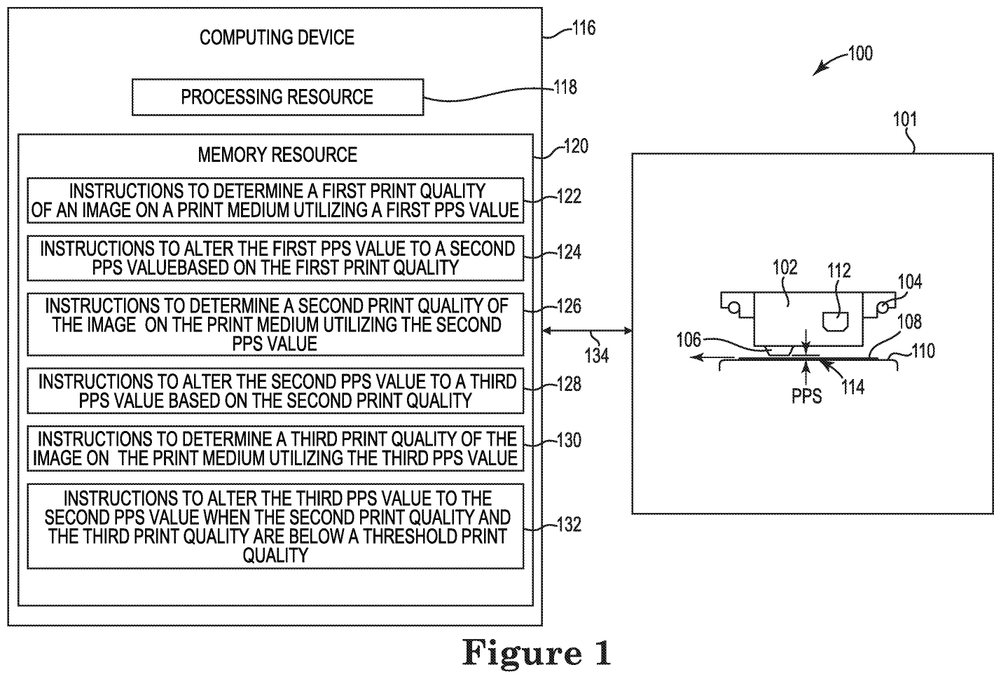

FIG. 1 is an example system 100 for print bar spacing calibrations consistent with the present disclosure. In some examples, the system 100 can include a print zone 101, In these examples, the print zone 101 can be a portion of a printing device where a print substance is deposited on to a print media 108. In some examples, the print zone 101 can include a rail system 104 that can be utilized to move a carriage 102 from a first end of the print zone 101 to a second end of the print zone 101. In some examples, rather than a carriage, media handling mechanisms may move the print media 108 relative to a stationary print head 106. In some examples, the print zone 101 can include a print head 106 (e.g., print bar with a plurality of print dies, print orifice, etc.) that can include a plurality of orifices to deposit a print substance on to the print media 108.

In some examples, the print zone 101 can include a print media area 110 to support print media 108 when the print head 106 deposits a print substance on to the print media 108. In some examples, the print zone 101 can include a paper to print bar spacing (PPS) 114 that corresponds to a distance between the print head 106 and the print media area 110. As described herein, the PPS 114 can affect the print quality of images generated by the printing device. In some examples the print zone 101 can include an adjustment mechanism 112 to alter a distance between the print head 106 and the print medium 108 (e.g., PPS 114, etc.). In some examples, the adjustment mechanism 112 can alter the PPS 114 in fixed increments (e.g., 0.1 millimeter increments, 0.2 millimeter increments, etc.). In other examples, the adjustment mechanism 112 can alter the PPS 114 in a continuous way such that the alteration can be a non-fixed increment (e.g., slides down a rail, lowered along a rail system, etc.).

In some examples, the adjustment mechanism 112 can be communicatively coupled to a computing device 116 such that the computing device 116 can alter the PPS 114 of the print zone 101 by providing instructions to the adjustment mechanism 112 through a communication path 134. As described herein, the PPS 114 can be altered based on an analysis of an image or plurality of images generated utilizing a plurality of different PPS values.

In some examples, the computing device 116 can be utilized as a controller for a printing device. In some examples, the computing device 116 can include a processing resource 118 and/or a memory resource 120 storing instructions to perform particular functions. A processing resource 118, as used herein, can include a number of processing resources capable of executing instructions stored by a memory resource 120. The instructions (e.g., machine-readable instructions (MRI), computer-readable instructions (CR1), etc.) can include instructions stored on the memory resource 120 and executable by the processing resource 118 to perform or implement a particular function. The memory resource 120, as used herein, can include a number of memory components capable of storing non-transitory instructions that can be executed by the processing resource 118.

The memory resource 120 can be in communication with the processing resource 118 via a communication link (e.g., communication path). The communication link can be local or remote to an electronic device associated with the processing resource 118, The memory resource 120 includes instructions 122, 124, 126, 128, 130, 132. The memory resource 120 can include more or fewer instructions than illustrated to perform the various functions described herein. In some examples, instructions (e.g., software, firmware, etc.) can be downloaded and stored in memory resource (e.g., MRM) as well as a hard-wired program (e.g., logic), among other possibilities. In other examples, the computing device 116 can be hardware, such as an application-specific integrated circuit (ASIC), that can include instructions to perform particular functions.

The computing device 116 can include instructions 122, that when executed by a processing resource 118 can determine a first print quality of an image on a print medium 108 utilizing a first PPS value (e.g., PPS 114 at a first distance, etc.). As used herein, a PPS value can be a PPS 114 or an adjustment value from a nominal PPS 114. In some examples, the computing device 116 can include instructions to alter the PPS 114 to a first distance to be utilized as the first PPS value. In other examples, the first PPS value can be a nominal PPS value or manufacturer PPS value as described herein.

In some examples, the computing device 116 can determine a plurality of PPS values to be utilized for a test image or plurality of test images, In some examples, the plurality of PPS values can include a first portion of PPS values that are greater than a nominal PPS value for the print zone 101 and a second portion of PPS values that are less than the nominal PPS value for the print zone 101. For example, the plurality of PPS values can include a total of five different PPS values. In this example, one of the PPS values can be the nominal PPS value for the print zone 101. In this example, two of the PPS values can be greater than the nominal PPS value and two of the PPS values can be less than the nominal PPS value. In this way, a print quality trend can be determined for a range of PPS values that are greater than the nominal PPS value and less than the nominal PPS value. In various examples, different sets of PPS values may be used. Furthermore, the nominal PPS value may be set at a maximum or minimum value rather than a value near the middle of a range of PPS values.

The computing device 116 can include instructions 124, that when executed by a processing resource 118 can alter the first PPS value to a second PPS value based on the first print quality. In some examples, the PPS 114 can be altered from a first PPS value to the second PPS value to identify a second print quality of the image utilizing the second PPS value. In some examples, the computing device 116 can alter the PPS 114 from the first PPS value to the second PPS value utilizing the adjustment mechanism 112. In some examples, the adjustment mechanism 112 can be a mechanical device that can raise or lower the print head 106 to alter the PPS 114 or distance between the print head 106 and the print medium 108.

In some examples, the computing device 116 can include instructions to determine that the first print quality of the image is below a print quality threshold or includes a quantity of print quality defects that exceeds a defect threshold. As used herein, a print quality threshold can be a threshold of quality that can be exceeded when a relatively low quantity of print quality defects are present. For example, the print quality threshold can utilize a defect threshold within the image and/or a portion of the image. In this example, an image that exceeds the defect threshold or a particular quantity of print quality defects can be described as being below the print quality threshold and/or above the defect threshold, Thus, the quantity of print quality defects can exceed a defect threshold and be utilized to determine that an image is below the print quality threshold. As used herein, a print quality defect can be an incorrect mark generated by depositing the print substance on to the print media. For example, a print quality defect can include an incorrect mark associated with die to die banding, die to die density, die to die alignment, missing nuzzling, ink mixing, and/or other incorrect marks. In some examples, the computing device 116 can alter the PPS from the first PPS value to the second PPS value in response to determining that the first print quality of the image is below the print quality threshold. In some examples, the first print quality and the second print quality can be the same or similar if the print quality defects are generated by a device or mechanism that is not affected by the PPS 114, For example, the print quality defects can be created by a missing or defective nozzle (e.g., print nozzle or orifice that is not depositing print substance at a correct location, a print nozzle that is not functioning, etc.). In this example, the adjustment of the PPS 114 may not result in a different print quality.

The computing device 116 can include instructions 126, that when executed by a processing resource 118 can determine a second print quality of the image on the print medium 108 utilizing the second PPS value. As described herein, the second PPS value can be a different PPS 114 than the first PPS value. In some examples, the first PPS value can be a nominal PPS value for the print zone 101 and the second PPS value can be a lower PPS value or greater PPS value than the first PPS value. In some examples, the difference between the first PPS value and the second PPS value can be based on a print quality trend. For example, the second PPS value can be selected as a better PPS value than the first PPS value when the print quality trend indicates that the second PPS value generates an image with a relatively higher print quality. In some examples, the print quality trend can be generated by the computing device 116 utilizing a test image that includes an image or a plurality of images that are generated utilizing a plurality of different PPS values. In this way, the computing device 116 can determine the second PPS value from a plurality of different PPS values based on the trend determined from the test image.

In other examples, the second PPS value can be an incremental increase or decrease from the first PPS value in order to determine the difference in print quality between the first PPS value and the second PPS value before selecting a PPS value to utilize during a normal operation of the printing device. As used herein, an incremental increase or decrease can be a single adjustment that is allowed by the adjustment mechanism 112. For example, the adjustment mechanism 112 can change the PPS 114 by 0.1 millimeter in a single adjustment. In this example, the incremental increase or decrease can be a 0.1 millimeter increase or decrease of the PPS 114. Thus, in some examples, the computing device 116 can make an incremental adjustment of the PPS 114 from the first PPS value to the second PPS value and determine the difference in print quality between the first PPS value and the second PPS value. In some examples, the incremental increase or decrease from the first PPS value to the second PPS value can be utilized to determine a corresponding increase or corresponding decrease of the print quality and/or print quality trend.

The computing device 116 can include instructions 128, that when executed by a processing resource 118 can alter the second PPS value to a third PPS value based on the second print quality. In some examples, the second print quality can be utilized to determine whether to alter the second PPS value to the third PPS value. For example, the computing device 116 can utilize the second print quality to determine if the second print quality is above a print quality threshold or include a relatively low quantity of print quality defects (e.g., fewer print quality defects than a defect threshold, etc.). In this example, the computing device 116 can alter the second PPS value to the third PPS value when the second print quality is below the print quality threshold or includes print quality defects that are above the defect threshold. That is, the computing device 116 can alter the second PPS value to the third PPS value when the second print quality includes a quantity of print quality defects that exceed a defect threshold, In other examples, the computing device 116 can alter the second PPS value to the third PPS value even when the second print quality is above the print quality threshold or includes print quality defects that are below the defect threshold to determine a print quality trend as described further herein.

The computing device 116 can include instructions 130, that when executed by a processing resource 118 can determine a third print quality of the image on the print medium utilizing the third PPS value, In some examples, the computing device 116 can determine the third print quality of the image by determining a quantity of print quality defects that are within the image on the print medium 108 or within a portion of the image on the print medium 108.

The computing device 116 can include instructions 132, that when executed by a processing resource 118 can alter the third PPS value to the second PPS value when the second print quality and the third print quality are above a threshold print quality and/or below a defect threshold, In some examples, the third PPS value and the second PPS value can both be acceptable or include a relatively low quantity of print quality defects, That is, the third PPS value and the second PPS value can each have a quantity of print quality defects that are below a defect threshold.

In some examples, the second PPS value can be a PPS 114 that is less than a nominal PPS value. For example, the first PPS value can be a nominal PPS value for the print zone 101. In this example, the second PPS value can be a PPS 114 that is less than the first PPS value. That is, the first PPS value can have a greater distance between the print medium 108 and the print head 106 than the second PPS value. In this example, the third PPS value can be less than the second PPS value and the first PPS value. In this example, the computing device 116 can alter the third PPS value to the second PPS value in order to provide a relatively larger PPS 114 during operation of the print zone 101.

In some examples, a relatively larger PPS 114 can allow for inconsistent placement of the print medium 108 on the print medium area 110. For example, a pathway can be utilized to transport the print medium 108 to the print medium area 110. In this example, a relatively larger PPS 114 can allow for more flexibility (e.g., margin of error, etc.) for the pathway to provide the print medium 108 without having the print medium 108 physically interact with a surface of the print head 106. In some examples, components of the print zone 101 and/or image generated on the print medium 108 can be damaged due to a physical interaction between the print medium 108 and the print head 106. For example, a physical interaction between the print medium 108 and the print head 106 can create a paper jam within the print zone 101. In some examples, a physical interaction between the print medium 108 and the print head 106 can result in depositing the print substance in a different location than an intended location, which can create a print quality defect as described herein.

In some examples, the computing device 116 can include instructions, that when executed by a processing resource 118 can determine a print quality trend for the first PPS value, the second PPS value, and the third PPS value. As described herein, a print quality trend can be generated utilizing a plurality of different PPS values. In some examples, a test page can be generated. In some examples, a first image generated utilizing the first PPS value, a second image generated utilizing the second PPS value, and a third image generated utilizing the third PPS value can be utilized to generate the print quality trend. In some examples, the first image, second image, and third image can be generated on corresponding print media 108 during a separate print process. For example, a first sheet of print media can be utilized to generate the first image, a second sheet of print media can be utilized to generate the second image, and a third sheet of print media can be utilized to generate the third image. In other examples, the first image, second image, and/or third image can be generated on the same sheet of print media,

In some examples, the first image, second image, and/or third image can be analyzed for print quality utilizing a scanning device. As used herein, a scanning device can include a device that is capable of converting an image generated on a print medium into a digital version of the image. In some examples, the scanning device can be an in-line scanning device (e.g., scanning device positioned within a print media pathway, etc.) or the scanning device can be an off-line scanning device (e.g., scanning device not positioned within the print media pathway, etc.). In some examples, the digital version of the first image, second image, and/or third image can be utilized to assign a print quality to the first image, second image, and/or third image. As described herein, the print quality can correspond to a quantity of print quality defects within the corresponding image and/or a portion of the corresponding image. In some examples, the print quality of the first image, second image, and/or third image can be utilized to generate a graphical representation of the print quality to determine the print quality trend. In some examples, the print quality trend can correspond to a slope of the print quality utilized to generate the graphical representation.

In some examples, the computing device 116 can include instructions, that when executed by a processing resource 118 can select a PPS value based on the print quality trend. In some examples, the print quality trend can represent a slope of a plurality of different PPS values being utilized for a plurality of corresponding images. In some examples, the print quality trend can be represented by a graphical representation of the print quality of images generated by the plurality of different PPS values, In some examples, the graphical representation can be utilized to determine when the print quality difference between different PPS values is negligible. As described herein, a relatively larger PPS value may be selected over a relatively lower PPS value to allow for a greater margin of error when delivering print media 108 to a print media area 110.

In some examples, the PPS value can be an offset PPS value. As used herein, an offset PPS value can include an adjusted distance to reach the offset PPS value based on the thickness of the print medium 108. For example, the offset PPS value can be 1.2 millimeters. In this example, the PPS 114 can be adjusted such that the resulting PPS value is 1.2 millimeters despite the thickness of the print medium 108. That is, the selected PPS value can be utilized to alter the PPS 114 based on the thickness of the print medium 108 such that the selected PPS value is achieved for the particular print medium 108. In other examples, the relatively larger PPS value may be selected over a relatively lower PPS value to accommodate a greater range of print media thickness of the print media 108. Thus, selecting the greater PPS value between the different PPS values can provide for a greater range of print media 108 to be utilized when it is determined that the print quality difference is negligible between different PPS values. For example, the computing device 116 can include instructions to determine that the print quality difference is negligible between a second image generated utilizing the second PPS value and a third image generated utilizing the third PPS value. In this example, the computing device 116 can include instructions to select the relatively larger PPS value or the PPS value that results in the greater PPS 114 to be utilized by the print zone 101.

The system 100 can be utilized to increase a print quality of a print zone 101 of a printing device. As described herein, the system 100 can determine a print quality for a plurality of different images that each utilized a different PPS 114. In addition, the system 100 can utilize the print quality of the plurality of different images to select a particular PPS 114 for the print zone 101. In this way, a PPS 114 for a print zone 101 can be altered to increase the print quality of images generated by the print zone 101 throughout the life cycle of the printing device. Thus, as the printing device degrades through use or is altered through use, the PPS 114 can be altered accordingly to maintain a print quality that is above a print quality threshold and/or below a defect threshold.

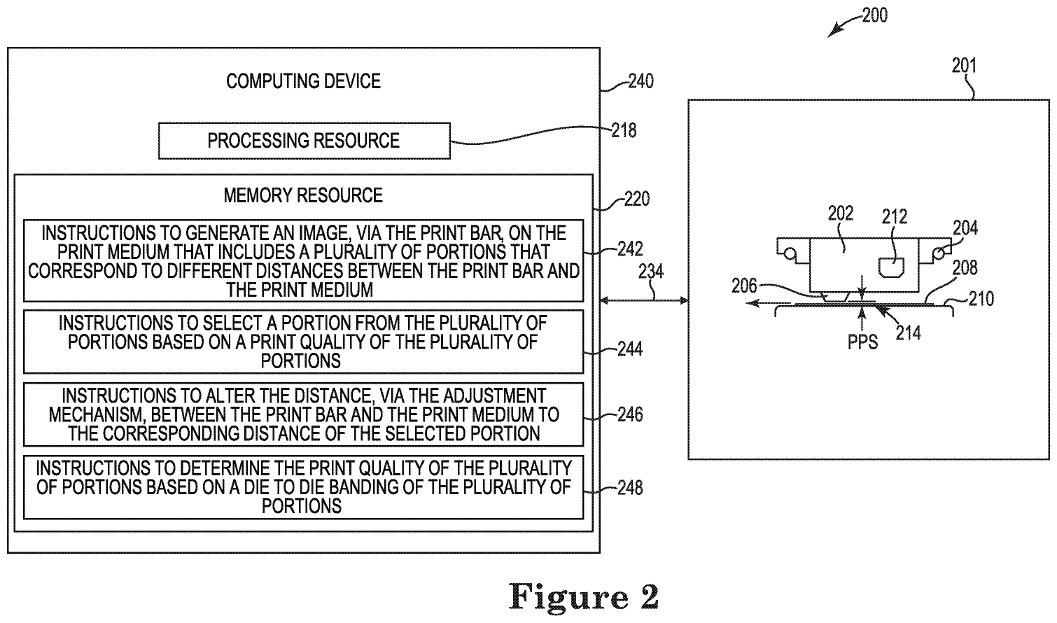

FIG. 2 is an example system 200 for print bar spacing calibrations consistent with the present disclosure. In some examples, the system 200 can include the same or similar elements as system 100 as referenced in FIG. 1. For example, the system 200 can include a print zone 201 that includes a carriage 202 coupled to a rail system 204. As described herein, the print zone 201 can include a print bar 206 (e.g., print head 106 as referenced in FIG. 1, etc.) with a PPS 214 between the print bar 206 and a print medium 208 positioned on a print media area 210. In some examples, the system 200 can include an adjustment mechanism 212 that can be utilized to adjust the PPS 214 to a particular PPS level or PPS value,

As described herein, the print bar 206 can include a plurality of dies to deposit a print substance on to the print medium 208 positioned on the print media area 210. In addition, the print media area 210 can be utilized to position the print medium 208 at a location to receive the print substance from the print bar 206. Furthermore, the adjustment mechanism 212 can be utilized to alter a distance between the print bar 206 and the print medium 208 (e.g., PPS 214) when the print medium 208 is positioned at the print media area 210.

The system 200 can include a computing device 216 communicatively coupled to the print zone 201. In some examples, the computing device 216 can be utilized as a controller for a printing device. In some examples, the computing device 216 can include a processing resource 218 and/or a memory resource 220 storing instructions to perform particular functions. In some examples, the computing device 216 can be a similar device as computing device 116 as referenced in FIG. 1.

The computing device 216 can include instructions 242, that when executed by a processing resource 218 can generate an image, via the print bar 206, on the print medium 208 that includes a plurality of portions that correspond to different distances between the print bar 206 and the print medium 208. In some examples, the image that is generated can include a plurality of portions generated on the same or single sheet of print medium 208. In other examples, the plurality of portions can be generated on a plurality of print media 208 (e.g., each portion generated on a corresponding sheet of print medium 208, a plurality of portions generated on a corresponding sheet of print medium 208, etc.).

In some examples, the image that is generated or a portion of the image that is generated can be a solid bar that extends from a first edge of the print medium 208 to a second edge of the print medium 208. For example, the image can include a first portion that includes a first bar generated at a first distance or first PPS value and a second portion that includes a second bar generated at a second distance or second PPS value. In some examples, the print quality of each of a plurality of bars of the image can be utilized to determine a print quality for a plurality of different PPS values. For example, each of the plurality of bars of the image can correspond to a particular PPS value or particular distance between the print bar 206 and the print medium 208. In this example, each of the plurality of bars can be analyzed to determine a print quality and/or to determine a quantity of print quality defects.

In some examples, the plurality of bars of the image can be scanned or digitized utilizing a scanning device. In some examples, the print zone 201 and/or the printing device can include an in-line scanning device that is capable of scanning the image for analysis. As used herein, an in-line scanning device can be a scanning device positioned within a print pathway of the printing device. For example, the print zone 201 can be utilized to generate the image on to the print medium 208 and a print pathway can move the print medium 208 from the print zone 201 to the in-line scanning device. In this example, the in-line scanning device can be positioned along the print pathway such that the print medium 208 can be scanned as the print medium 208 is transported from a first location to a second location of the printing device (e.g., transported from the print zone 201 to an output tray, etc.). In some examples, the print zone 201 can include an optical sensor to determine a reflectance of the image for analysis. In some examples, the optical sensor can include a device that can determine an effectiveness of an image or portion of the image to reflect radiant energy. In some examples, the reflected radiant energy can correspond to a particular print quality. For example, the reflected radiant energy can be utilized to identify a quantity of print quality defects as described herein when the print quality defects alter the effectiveness of reflecting radiant energy.

The computing device 216 can include instructions 244, that when executed by a processing resource 218 can select a portion from the plurality of portions based on a print quality of the plurality of portions. In some examples, the computing device 216 can select a portion from the plurality of portions based on a quantity of print quality defects associated with the plurality of portions. In some examples, the computing device 216 can select a portion from the plurality of portions when the portion includes print quality defects that are below a defect threshold of print quality defects. In other examples, the computing device 216 can select a portion from a subset of the plurality of portions that each include print quality defects that are below the defect threshold of print quality defects. In these examples, the computing device can select the largest PPS value or portion that corresponds to the largest PPS value from the subset of the plurality of portions.

The computing device 216 can include instructions 246, that when executed by a processing resource 218 can alter the distance, via the adjustment mechanism 212, between the print bar 206 and the print medium 208 to the corresponding distance of the selected portion. As described herein, the selected portion can be generated utilizing a particular PPS value. The computing device 216 can send an instruction to the adjustment mechanism 212 via communication path 234 to alter the PPS 214 to the corresponding PPS value utilized to generate the selected portion.

The computing device 216 can include instructions 248, that when executed by a processing resource 218 can determine the print quality of the plurality of portions based on a die to die banding of the plurality of portions. As described herein, the print quality of the plurality of portions can be analyzed to determine a quantity of print quality defects. In some examples, the print quality defects can include die to die banding. As used herein, die to die banding can include print quality defects that are positioned at locations on the print medium 208 that corresponds to spaces between dies of the print bar 206. In some examples, other types of print quality defects can be utilized to determine the print quality of the plurality of portions.

The system 200 can be utilized to increase a print quality of a print zone 201 of a printing device. As described herein, the system 200 can determine a print quality for a plurality of different images that each utilized a different PPS 214. In addition, the system 200 can utilize the print quality of the plurality of different images to select a particular PPS 214 for the print zone 201. In this way, a PPS 214 for a print zone 201 can be altered to increase the print quality of images generated by the print zone 201 throughout the life cycle of the printing device. Thus, as the printing device degrades through use or is altered through use, the PPS 214 can be altered accordingly to maintain a print quality that is above a print quality threshold and/or includes a quantity of print quality defects that is below a defect threshold.

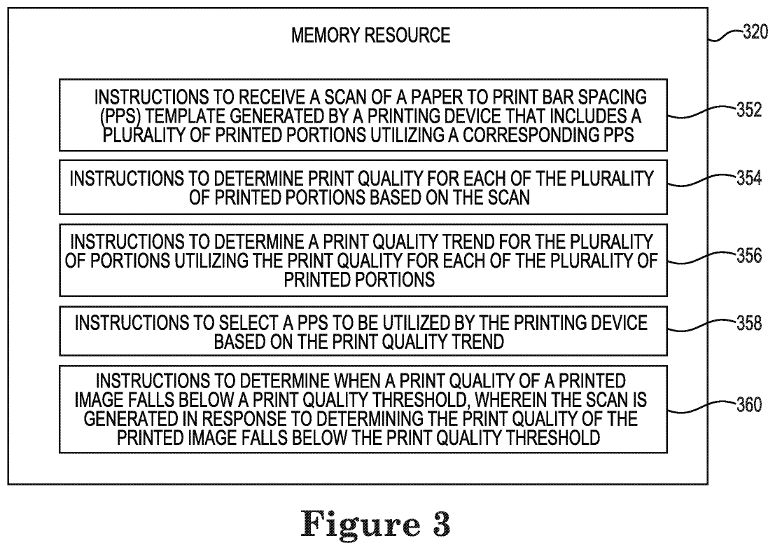

FIG. 3 is an example memory resource 320 for print bar spacing calibrations consistent with the present disclosure. In some examples, the memory resource 320 can be part of a controller or computing device as described herein. The memory resource 320 can be the same or similar as memory resource 120 as referenced in FIG. 1 and/or memory resource 220 as referenced in FIG. 2.

In some examples, the memory resource 320 can include instructions 352, that when executed by a processing resource can receive a scan of a paper to print bar spacing (PPS) template generated by a printing device that includes a plurality of printed portions utilizing a corresponding PPS, As described herein, the PPS template can be a test page or test pages that can include an image with a plurality of portions where each portion is generated by a corresponding PPS or PPS value, In some examples, the memory resource 320 can receive a scanned version of the PPS template.

As described herein, a printing device can include a scanning device to scan or digitize the PPS template after the PPS template is generated. In some examples, the printing device can include an in-line scanning device that can scan the PPS template while the PPS template is transported from a first location of the printing device to a second location of the printing device.

In some examples, the memory resource 320 can include instructions 354, that when executed by a processing resource can determine print quality for each of the plurality of printed portions based on the scan. As described herein, the print quality for the plurality of printed portions can be determined by identifying a quantity of print quality defects within each of the plurality of portions and determine the print quality for the plurality of portions based on the quantity of print quality defects. In some examples, a subset of the plurality of portions can be selected based on the quantity of print quality defects.

For example, the subset of the plurality of portions can include portions that are identified as having a print quality that is within an acceptable range. In this example, the subset of the plurality of portions can be portions that have a quantity of print quality defects that are below a print quality threshold. Thus, in this example, the subset of the plurality of portions can include relatively fewer print quality defects and/or have a relatively higher print quality compared to the other portions of the plurality of portions.

In some examples, the memory resource 320 can include instructions 356, that when executed by a processing resource can determine a print quality trend for the plurality of portions utilizing the print quality for each of the plurality of printed portions. As described herein, a print quality trend can include a trend that is identified by a graphical representation of the print quality for the plurality of portions. In some examples, the graphical representation can indicate a trend of increased print quality between the plurality of different PPS values. In some examples, the print quality trend can indicate when an increase in print quality from a first PPS value to a second PPS value is negligible. In some examples, the print quality trend can indicate when a relatively larger PPS value provides a similar print quality to a relatively smaller PPS value. In this way, the memory resource 320 can select the relatively larger PPS value and obtain a similar print quality.

In some examples, the memory resource 320 can include instructions 358, that when executed by a processing resource can select a PPS to be utilized by the printing device based on the print quality trend. As described herein, the selected PPS value can be a PPS value with a print quality that is below a print quality threshold and/or includes a relatively lower quantity of print quality defects compared to other PPS values. In some examples, the memory resource 320 can include instructions to alter the PPS for a print zone by sending an instruction to an adjustment mechanism of the printing device to alter a current PPS to the selected PPS.

In some examples, the memory resource 320 can include instructions 360, that when executed by a processing resource can determine when a print quality of a printed image falls below a print quality threshold, wherein the scan is generated in response to determining the print quality of the printed image falls below the print quality threshold. In some examples, a PPS template can be generated in response to a scanned image indicating that the print quality of an image generated by the printing device is below a print quality threshold and/or includes a relatively large quantity of print quality defects.

In some examples, the memory resource 320 can receive scanned images of images generated by the printing device. In these examples, the printing device can utilize an in-line scanning device to periodically scan images generated by the printing device. In these examples, the memory resource can determine when the scanned images fall below a print quality threshold or exceed a threshold quantity of print quality defects. That is, the memory resource 320 can begin print bar spacing calibrations in response to an image generated by the printing device being below the print quality threshold.

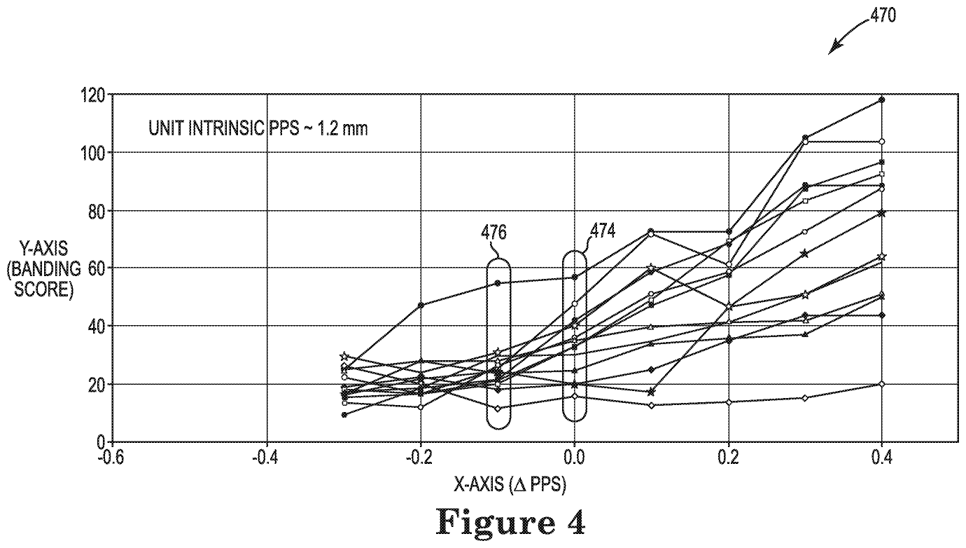

FIG. 4 is an example graphical representation 470 for print bar spacing calibrations consistent with the present disclosure. In some examples, the graphical representation 470 can include a trend graph that corresponds to a particular printing device. The graphical representation 470 can include an adjusted PPS value from the nominal PPS value on the x-axis and a calculated banding score on the y-axis. In some examples, the graphical representation 470 can represent a printing device that utilized a nominal PPS value of 1.2 millimeters. However, a graphical representation 470 can be generated for a plurality of different printing devices that utilize a plurality of different nominal PPS values.

In some examples, the graphical representation 470 can include a nominal PPS value that generated the banding scores at a 0.0 PPS value 474, which can have an adjusted PPS value of 0.0 millimeters since the nominal PPS value can represent a manufacturer PPS value or a PPS value that is currently utilized by the printing device. In some examples, each of the adjusted PPS values can include a plurality of values that correspond to a banding score for the plurality of dies at that particular adjusted PPS value. For example, each value can be a calculated banding score for an area of the image that corresponds to a space between a first corresponding die and a second corresponding die of the plurality of dies. In some examples, the graphical representation 470 can illustrate banding scores from a printing device utilizing 14 dies and thus includes 13 curves or 13 values at each adjusted PPS value (e.g., 13 spaces between the 14 dies, etc.).

In some examples, an overall print quality for the image can be determined based on a relative closeness between the banding scores at a particular PPS value. In some examples, the closer the banding scores at a particular altered PPS value can correspond to a better overall print quality. For example, the plurality of banding scores of the nominal PPS value at the 0.0 PPS value 471 can be relatively closer than the plurality of banding scores of the +0.4 PPS value. In this way, it can be determined that the overall print quality of an image generated utilizing the nominal PPS value can be better than the print quality of an image generated utilizing the +0.4 PPS value, As described herein, the nominal PPS value for the graphical representation 470 can be 1.2 millimeters. Thus, the PPS at the 0.0 PPS value can be 1.2 millimeters and the PPS at the +0.4 PPS value can be 1.6 millimeters.

As described herein, the graphical representation 470 can be utilized to determine a trend of the print quality based on the banding scores or print quality associated with the different adjusted PPS values aligned on the x-axis. For example, a trend can be determined as a linear relationship between +0.4 PPS value and the −0.3 PPS value. In this example, a determination can be made that the −0.1 PPS value is to be selected when the trend indicates that the print quality between the −0.1 PPS value and the −0.2 PPS value is negligible. Thus, in this example, the −0.1 PPS value at 476 can be selected. In some examples, an adjustment mechanism can adjust the nominal PPS value of the printing device a value of −0.1 millimeters based on the graphical representation 470.

The above specification, examples and data provide a description of the method and applications and use of the system and method of the present disclosure. Since many examples can be made without departing from the spirit and scope of the system and method of the present disclosure, this specification merely sets forth some of the many possible example configurations and implementations.

What is claimed:

1. A printing device, comprising:
a print zone that includes a print head and a print media area, wherein the print zone includes a paper to print head spacing (PPS) that corresponds to a distance between the print head and the print media area; and
a computing device comprising instructions to:
determine a first print quality of an image on a print medium utilizing a first PPS value; and
alter the first PPS value to a second PPS value based on the first print quality.

2. The printing device of claim 1, wherein the computing device comprises instructions to:
determine a second print quality of the image on the print medium utilizing the second PPS value;
alter the second PPS value to a third PPS value based on the second print quality; and
determine a third print quality of the image on the print medium utilizing the third PPS value.

3. The printing device of claim 2, wherein the computing device comprises instructions to alter the third PPS value to the second PPS value when the second print quality and the third print quality are above a threshold print quality.

4. The printing device of claim 2, wherein the computing device comprises instructions to:
determine a print quality trend for the first PPS value, the second PPS value, and the third PPS value; and
select a PPS value based on the print quality trend.

5. The printing device of claim 4, wherein the print quality trend is determined in response to an image generated by the print zone exceeding a quantity of print quality defects.

6. A system, comprising:
a print bar that includes a plurality of dies to deposit a print substance on to a print medium positioned on a print media area;
the print media area to position the print medium at a location to receive the print substance from the print bar;
an adjustment mechanism to alter a distance between the print bar and the print medium when the print medium is positioned at the print media area; and
a controller comprising instructions to:
generate an image, via the print bar, on the print medium that includes a plurality of portions that correspond to different distances between the print bar and the print medium; and
select a portion from the plurality of portions based on a print quality of the plurality of portions; and
alter the distance, via the adjustment mechanism, between the print bar and the print medium to the corresponding distance of the selected portion.

7. The system of claim 6, wherein the controller comprises instructions to determine the print quality of the plurality of portions based on a die to die banding of the plurality of portions.

8. The system of claim 6, wherein the controller comprises instructions to:
determine a print quality trend of the image; and
select the portion from the plurality of portions based on the print quality trend of the image.

9. The system of claim 8, wherein the controller comprises instructions to select the portion from the plurality of portions in response to the portion corresponding to a greatest distance among portions having a print quality that is above a print quality threshold.

10. The system of claim 6, comprising an inline scanning device to scan the generated image, wherein the scanned image is utilized to determine the print quality for the plurality of portions.

11. The system of claim 10, wherein the scanned image is utilized to identify die to die banding, die to die density, die to die alignment, missing nuzzling, and print substance mixing for the plurality of portions.

12. The system of claim 6, wherein the plurality of portions include a first portion that corresponds to a nominal distance, a second portion that corresponds to a distance that is greater than the nominal distance, and a third portion that corresponds to a distance that is less than the nominal distance.

13. A non-transitory computer-readable storage medium comprising instructions when executed cause a processor of a computing device to:
receive a scan of a paper to print bar spacing (PPS) template generated by a printing device that includes a plurality of printed portions utilizing a corresponding PPS;
determine print quality for each of the plurality of printed portions based on the scan;
determine a print quality trend for the plurality of portions utilizing the print quality for each of the plurality of printed portions; and
select a PPS to be utilized by the printing device based on the print quality trend.

14. The non-transitory computer-readable storage medium of claim 13, wherein the print quality trend is based on a plurality of banding scores associated with each of the plurality of portions.

15. The non-transitory computer-readable storage medium of claim 13, comprising instructions to determine when a print quality of a printed image falls below a print quality threshold, wherein the scan is generated in response to determining the print quality of the printed image falls below the print quality threshold.
